(19) United States
(12) Patent Application Publication
(10) Pub. No.: US 2012/0311639 A1
(43) Pub. Date: Dec. 6, 2012

(54) VIDEO SEARCHING USING TV AND USER INTERFACES THEREFOR

(75) Inventors: Seth Guy Hill, La Mesa, CA (US); Ted Mark Dunn, Carlsbad, CA (US); Jaime Chee, San Diego, CA (US)

(73) Assignee: SONY CORPORATION

(21) Appl. No.: 13/275,817

(22) Filed: Oct. 18, 2011

Related U.S. Application Data
(63) Continuation-in-part of application No. 13/152,757, filed on Jun. 3, 2011.

(51) Int. Cl. H04N 21/482

(52) U.S. Cl. 725/53

(57) ABSTRACT

A viewer watching a video program on a display of an audio-video device can select a “Video Search” application indicating viewer desire to obtain information about a currently playing video program. The application is invoked to send name of the currently playing video program to a server associated with a database to cause the server to execute a search of the database. The server returns metadata related to the currently playing video program, which is presented on the display along with the currently playing video program. The metadata includes links to additional information, such as cast members associated with the video program. The links are selectable to cause the server to execute a search of the database for metadata relating to the additional information, which is returned to the AV device and presented on the display along with the currently playing video program.

This application claims priority from U.S. patent application Ser. No. 13/152,757, filed Jun. 3, 2011.

### I. FIELD OF THE INVENTION

The present application relates generally to video searching using TVs and user interfaces (UI) related to the searching.

### II. BACKGROUND OF THE INVENTION

Audio video (AV) devices such as TVs are growing increasingly capable, enabling viewers to watch videos from a wide range of sources with concomitant features. As understood herein, presenting additional information to viewers in an easy, intuitive, and non-cluttered way is desirable as more consumers demand increased access to supplemental information without wanting to operate computers to obtain the information.

### SUMMARY OF THE INVENTION

A method includes receiving, from a viewer watching an audio-video (AV) program on a video display, selection of a “Video Search” application indicating viewer desire to obtain information about a currently playing AV program. The method then includes, responsive to selection of the “Video Search” application, invoking the “Video Search” application. The “Video Search” application is executed to send a name of the currently playing AV program to a server associated with a database to cause the server to execute a search of the database. Thereafter, metadata related to the currently playing AV program is received from the server. The metadata includes information about the currently playing AV program and the cast of the currently playing AV program, but may also include other information, such as, e.g., writers and directors associated with the second AV program. Information from the metadata related to the currently playing AV program is then presented on the video display along with the currently playing AV program.

Furthermore, responsive to viewer input indicating viewer desire to obtain information about the cast member, the method also includes executing the “Video Search” application a second time to send a name of a cast member associated with the currently playing AV program to a server associated with a database to cause the server to execute a search of the database associated with the server. Metadata related to the cast member is then received from the server. The metadata includes information about the cast member and/or the names of AV programs with which the cast member is associated. For example, in exemplary embodiments the metadata related to the cast member presented on the video display may include bibliographic information of the cast member. Information from the metadata related to the cast member is then presented on the video display along with the currently playing AV program.

If desired, responsive to viewer input indicating viewer desire to obtain information about a second AV program, the method may further include executing the “Video Search” application a third time. The “Video Search” application sends the name of a second AV program with which the cast member is associated (that is different than the currently playing AV program) to a server associated with a database. The server is then caused to execute a search of the database associated with the server. Then metadata related to the second AV program is then received from the server. The metadata may include information about the second AV program and the cast of the second AV program, but may also include other information such as, e.g., writers and directors associated with the second AV program. Information from the metadata related to the second AV program is then presented on the video display along with the currently playing AV program.

Also if desired, in the alternative or in addition to executing the “Video Search” application for a second AV program with which the cast member is associated as described immediately above, the method may include receiving from the viewer a search command to search for information related to an AV program not being presented on the video display. In response to the viewer search command, the method includes presenting a search tab on the video display. User input is then received to the search tab and, responsive to the user input to the search tab, the method includes sending the user input to a server and causing the server to execute a database search for information related to the user input to the search tab. Thereafter, metadata is received from the server that is related to the AV program not being presented on the video display and input to the search tab. The metadata thus includes information about the AV program not being presented on the video display. The information is presented on the video display along with the currently playing AV program.

In exemplary embodiments, metadata received from the server(s) to be presented on the video display in accordance with present principles may include at least one link associated with the cast member's name that is selectable to cause executing of the “Video Search” application responsive to selection of the link. Thus, responsive to selection of the link, the name of a cast member associated with the currently playing AV program is sent to the server associated with the database to cause the server to execute a search of the database associated with the server in accordance with present principles. Additionally, the link can be selectable by a viewer using a TV remote control and/or a keyboard to select the link and not using a computer.

Furthermore, in some embodiments, the “Video Search” application may cause the server to execute searches only of a database(s) associated with an Internet server(s), and not to execute searches of the Internet. In addition, the database searched for metadata relating to the name of the currently playing AV program may be performed on the same database as the database searched for metadata relating to the cast member. However, the database searched for metadata relating to the name of the currently playing AV program may alternatively be performed on a different database than the database searched for metadata relating to the cast member.

In another aspect, an AV device includes a video display presenting a currently input AV program. The AV device also includes a processor accessing instructions on a computer readable medium to execute the instructions to control the video display to present a user interface (UI) on the video display while simultaneously presenting an AV program on the video display. The UI includes an “information” selector element. Responsive to selection of the “information” selector element, the processor presents on the video display first metadata (e.g., a first set or group of metadata) relating to the AV program. Responsive to selection of a link in the first metadata, the processor replaces the first metadata with second metadata (e.g., a second set or group of metadata) relating to subject matter associated with the link and different from the subject matter of the first metadata.

In still another aspect, a method includes receiving, from a viewer watching an AV program on a video display of an AV device, selection of a “search” selector element from a UI presented on the video display. Selection of the “search” selector element indicates viewer desire to obtain information about an AV program currently presented on the AV device. Thus, responsive to selection of the “search” selector element, a search application is invoked. The search application is then executed to send a name of the AV program to a server associated with a database to cause the server to execute a search of the database. The method then includes receiving from the server metadata related to the AV program, the metadata understood to include information about the AV program. The information from the metadata is presented on the video display.

The method further includes executing the search application at least a second time. When executed a second time, a seed other than the name of the AV program is sent to a server associated with a database to cause the server to execute a search of the database. This is done responsive to viewer input indicating viewer desire to obtain information about the seed, the seed being different than the name of the AV program. The seed can be derived from the information about the AV program presented on the video display. Metadata related to the seed is then received from the server. It is to be understood that the metadata can include supplementary information related to the first seed. The supplementary information from the metadata is then presented on the video display.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a flow chart showing example overall logic in accordance with present principles;

FIG. 3 is a flow chart showing example “search apps” logic;

FIG. 4 is a screen shot of a user interface (UI) illustrating various portions and selector elements;

FIG. 5 is a screen shot of a search UI;

FIG. 6 is a screen shot of a UI that is presented responsive to selection of the video tab and the seed is “video”;

FIG. 7 is a screen shot of a UI that is presented responsive to selection of the video tab and the seed is “cast”;

FIG. 8 is a screen shot of a UI that is presented responsive to selection of the cast tab and the seed is “video”;

FIG. 9 is a screen shot of a UI that is presented responsive to selection of the cast tab and the seed is “cast”;

FIG. 10 is a screen shot of a UI that is presented responsive to selection of the “related” tab (seed must be “video”);

FIG. 11 is a screen shot of a text search pop-up window that is presented when the text search tab is selected;

FIG. 12 is a screen shot of a UI that presents results of the search entered from the UI of FIG. 11;

FIG. 13 is a screen shot of a UI that is presented responsive to selection of the seed history tab (seed can be “video” or “cast”);

FIG. 14 is a screen shot of a UI that is presented responsive to selection of the bookmark tab; and

FIG. 15 is a flow chart showing example “search apps” logic illustrating recursive searching.

### DETAILED DESCRIPTION OF THE PREFERRED EMBODIMENT

Referring initially to FIG. 1, an audio video (AV) display device 12 such as a TV includes a housing 14 bearing a digital processor 16. The processor 16 can control a visual display 18 and an audible display 20 such as one or more speakers. The visual display may be a touch screen display or high definition TV display or other appropriate video display.

To undertake present principles, the processor 16 may access one or more computer readable storage media 22 such as but not limited to RAM-based storage (e.g., a chip implementing dynamic random access memory (DRAM)) and/or flash memory and/or disk-based storage. Software code implementing present logic executable by the AV device 12 may be stored on one of the memories to undertake present principles.

If desired, in addition to the touch screen the processor 16 can receive user input signals from various input devices, including a keypad, a remote control device 26, a point and click device such as a mouse, etc. A TV tuner 28 may be provided in some implementations particularly when the CE device is embodied by a TV to receive TV signals from a source such as a set-top box, satellite receiver, cable head end, terrestrial TV signal antenna, etc. Signals from the tuner 28 are sent to the processor 16 for presentation on the display 18 and speakers 20.

As shown in FIG. 1, a network interface 30 such as a wired or wireless modem or wireless telephony transceiver communicates with the processor 16 to provide connectivity to one or more Internet servers, including a management server 32 with respective processors 32a and respective computer readable storage media 32b. The management server 32 may provide the AV device 12 with selective access to AV content from one or more asset servers 34. One or more AV input ports 36 can also be provided to receive television programming from respective sources including a disk player, a set top box, a cable head end, a satellite, a terrestrial broadcast antenna.

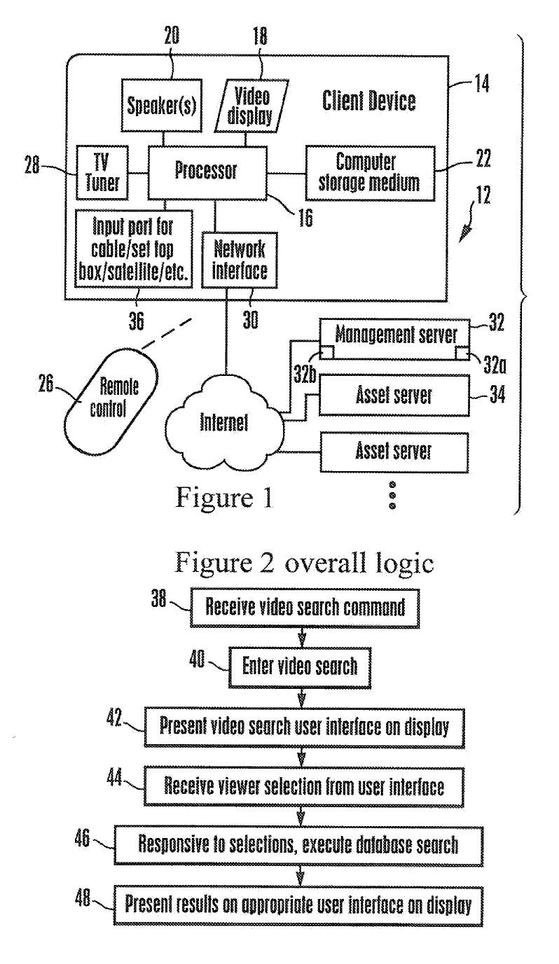

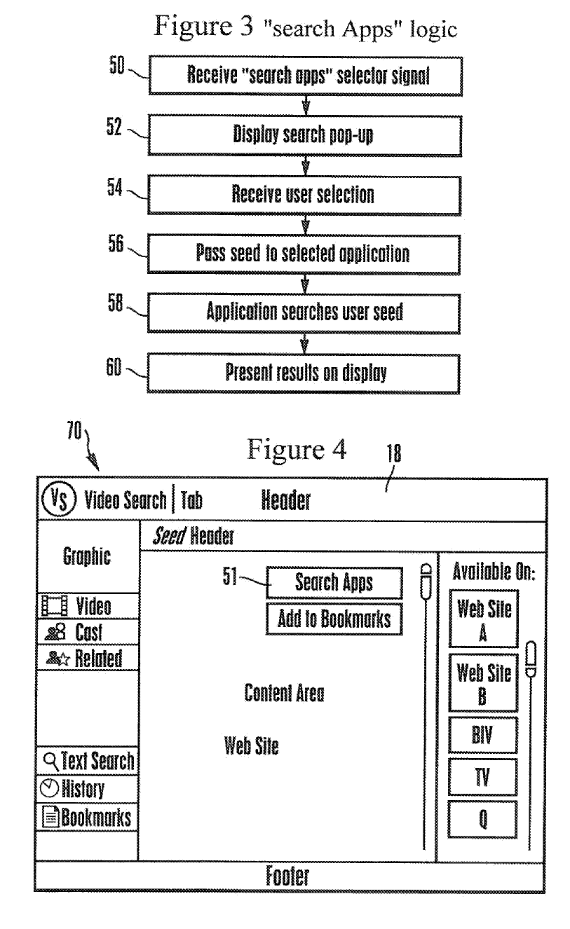

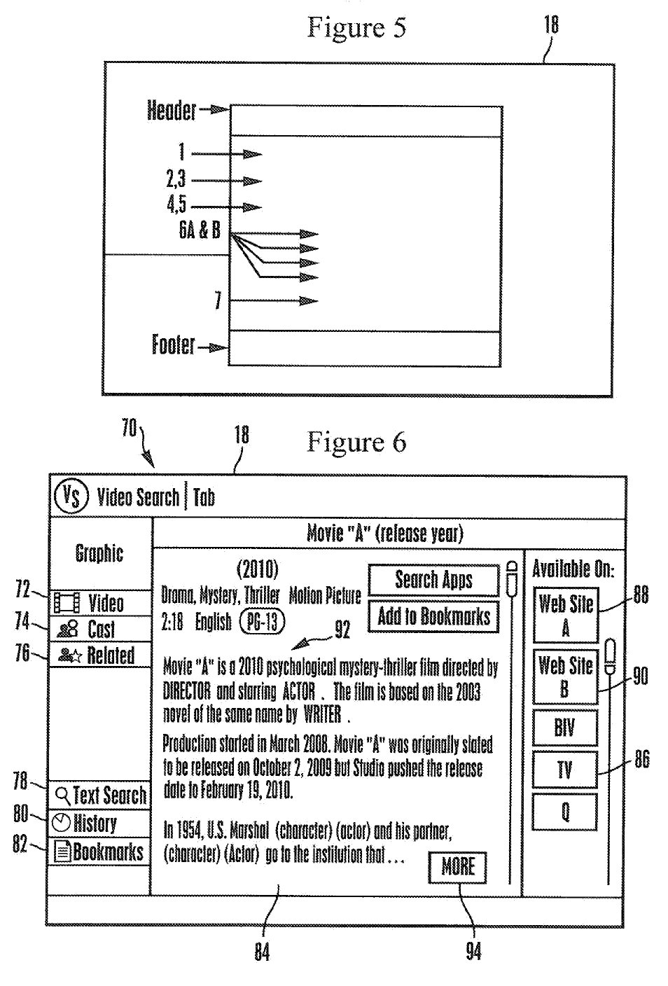

FIGS. 2 and 3 illustrate logic that the processor 16 accessing the medium 22 may execute. Commencing at block 38 a video search command is received from a viewer operating the below-described user interface (UI) shown in FIG. 4. A video search algorithm is entered at block 40 to present on the display 18 a search UI at block 42. An example search UI is described further below in reference to FIG. 5.

Proceeding to block 44, user selections are received from the search UI. At block 46, responsive to the user selections a database (not Internet) search is conducted for matching content, with results being presented on display 18 at block 48.

FIG. 3 shows more specific search logic. Commencing at block 50, the processor receives from a viewer operating the UI of FIG. 4, a window (labeled “Content Area”) of which presents broadcast TV or Internet video content, a selection of a “Video Search” application indicating viewer desire to obtain information about a currently playing video program. The video search application allows users to search for information about videos and cast members and can be entered by manipulating, e.g., the RC 26 to select a “search apps” selector element 51 on the UI of FIG. 4.

Responsive to selection of the “Video Search” application, at block 52 the pop-up UI of FIG. 5 is overlaid onto the UI of FIG. 4, although in some embodiments the UI of FIG. 5 can completely replace the UI of FIG. 4. In any case, a user selection of a “seed” such as a video title or cast member name is received at block 54 and passed to a selected application at block 56. The application searches a predetermined database at block 58 for matching content and returns the content for presentation on the display 18 at block 60.

In the UI shown in FIG. 5, a header may be presented as shown, and the “seed” entered into block #1. The seed may be entered by typing in the name of a title or person and may be automatically correlated to the “video” genus by searching a database of video names and responsive to a match being found, inferring that the viewer has entered a “seed” which is a video title. Similarly, the seed may be automatically correlated to the “cast” genus by searching a database of person names and responsive to a match being found, inferring that the viewer has entered a “seed” which is a cast member name. Or, the viewer may directly enter “video” or “cast” or may toggle between “video” and “cast” using the RC 26.

Block #2 in FIG. 5 may be a video icon when “video” is the seed and block #3 may be the entered video title. Likewise, when “cast” is the seed block #3 may be an icon (e.g., photo) of the selected cast member and block #4 may be the cast title, either personal name, character name, etc. Rows 4 and 5 may be reserved and row #6A and 6B may be an icon and item name, respectively, associated with a selected application, e.g., an Internet TV application or a music search application. Line #7 may be a help text field.

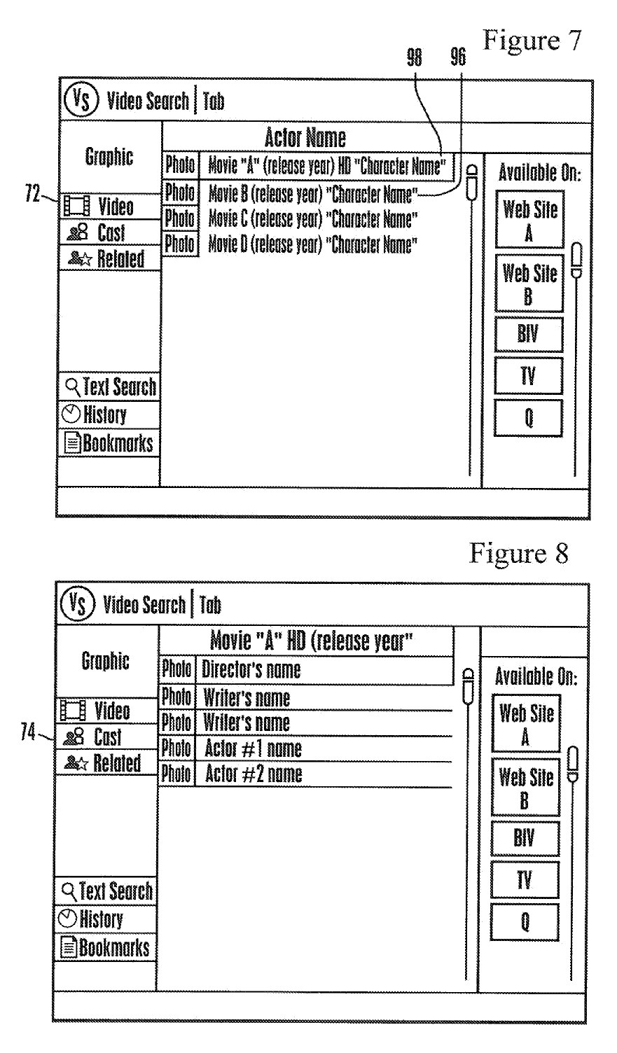

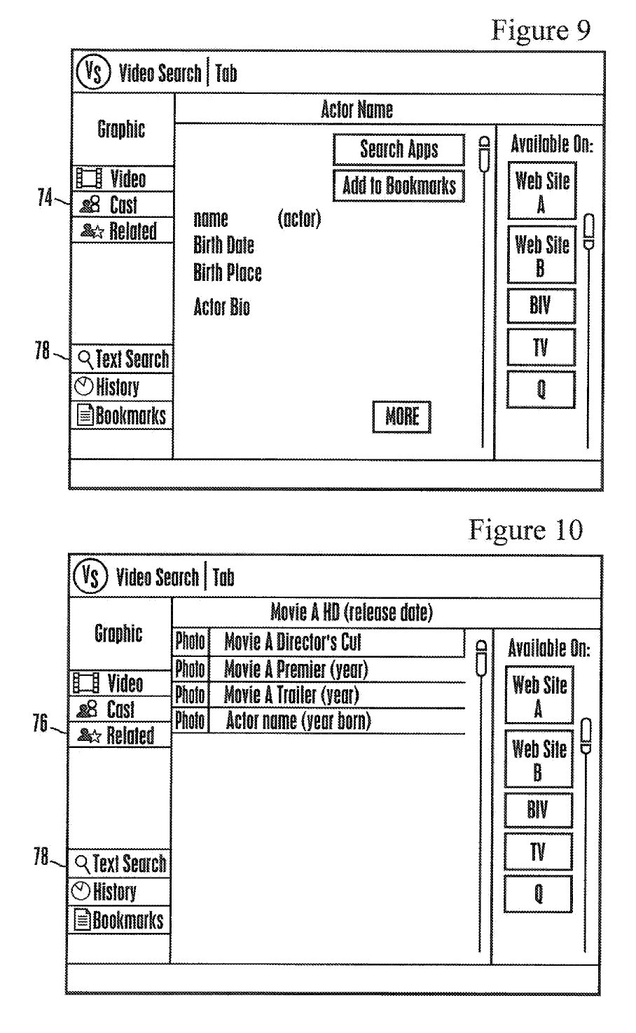

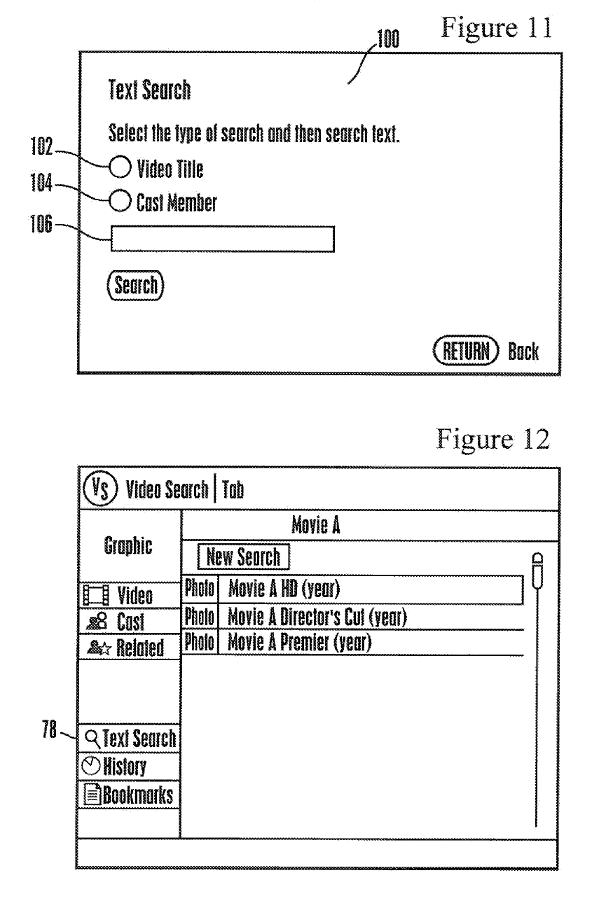

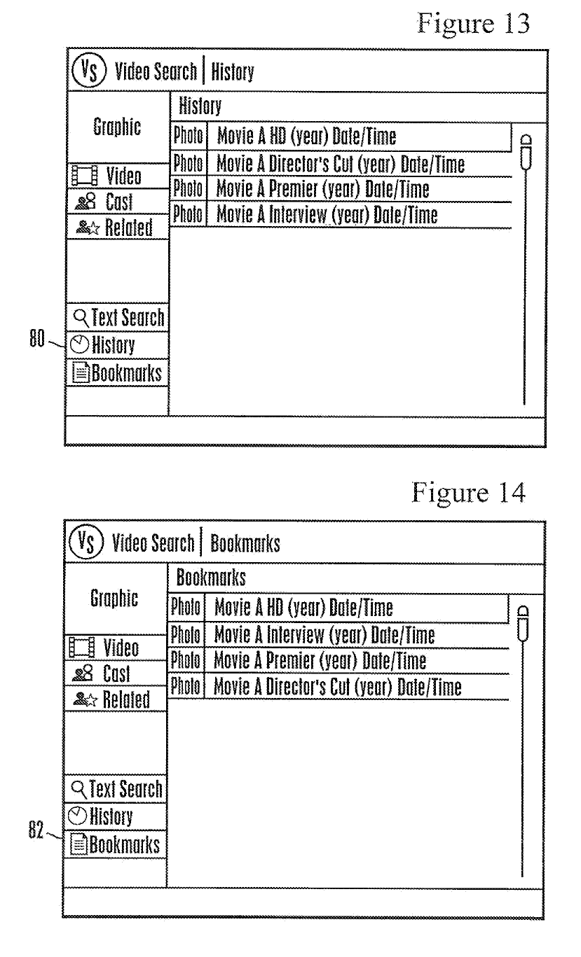

FIGS. 6-14 illustrate various configurations that may be assumed by the UI shown in FIG. 4, hereinafter designated UI 70. In the example shown, the UI 70 includes a left-most column of tabs, in order from top to bottom a video tab 72 (which is depicted as being selected in FIGS. 6 and 7), a cast tab 74 (selected in FIGS. 8 and 9), a related tab 76 (selected in FIG. 10), a text search tab 78 (selected in FIG. 12), a history tab 80 (selected in FIG. 13), and a bookmarks tab 82 (selected in FIG. 14). As discussed further below, the UI 70 can be used to provide links that allow users to navigate to videos and cast members related to content in the main information/video area discussed further below. This creates an “exploratory” environment, enabling users to jump from one group of information to another. The users can access information about the currently playing video. Or the users can access a keyboard in order to enter and then search for any video topic or music track played on the AV device 12.

As shown in FIG. 6, moving to the right on the display 18 a main information/video area 84, labeled “content area” in FIG. 4, occupies the majority of the display area. Description below follows as to what is presented in the main information area 84.

To the right of the main information area 84, in some example implementations a column of selector elements or icons may be presented which a viewer can select respective AV program sources including at least one TV signal source (associated with an icon 86) and at least one Internet source (Internet sources are associated with website icons 88, 90). The icons represent sources from which content related to the seed name is available. An icon is selectable to cause the content related to the seed name to be received from the respective source.

FIG. 6 shows that responsive to selection of the video tab 72 in the above-described seed mode of “video”, the processor 16 presents in the main information area 84 of the UI 70 a description 92 of a currently input AV program to the device 12, in the example shown, “movie A”. The description, like the other supplemental information described herein responsive to the selection of various tabs, may be downloaded from the management server 32 accessing various asset servers 34. The description can include the year of release of the program, its genre, run time, and language as shown in FIG. 6. Also, the description can include, as shown, a brief summary of the movie connections, production information, and a plot summary. A “more” selector element 94 can be selected to scroll the screen up for additional information on the current AV program.

On the other hand, responsive to selection of the video tab 72 in the seed mode of “cast”, as shown in FIG. 7 titles 96 are presented of AV programs other than the currently input AV program 98, with the titles 96 also starring or otherwise associated with a currently designated person associated with the currently input AV program 94. Along with each title 96, the actor's character name in the underlying AV program can be presented as shown along with a release year for that program and if desired, to the left of the title, a photo, e.g., of the actor in the character role.

In further contrast, FIG. 8 shows that responsive to selection of the cast tab 74 while in the seed mode of “video”, the UI names of people associated with the currently input AV program and, if desired, their photos, whereas responsive to selection of the cast tab 74 in a seed mode of “cast” (FIG. 9) the processor presents on the UI biographic information of the currently designated person including, e.g., the person's name, date and place of birth, and a brief biography.

FIG. 10 shows that selection of the related tab 76 causes the processor 16 to present on the UI AV programs that are associated with the currently input AV program including differently edited versions of the currently input AV program, e.g., “premier”, “High definition”, “trailer”, etc. On the other hand, when the text search tab 78 is selected a pop-window 100 may be overlaid on the main UI 70. The pop up window 100 as shown permits a user to select from a video category 102 and a cast member category 104, and in example embodiments no other categories are selectable. The window 100 can include a pane 106 into which a user can enter one or more search terms. The processor executes a search on the selected category using the one or more search terms and then precipitate a search of, e.g., the management server 32 and asset servers 34 only by selecting “search”. FIG. 12 shows that when the search is complete the window 100 is removed and the UI 70 presents a list of video programs that confirm to the query input into the window 100, including accompanying photos if desired and release year.

Still further, selection of the “history” tab 80 as shown in FIG. 13 causes the UI 70 to present a list of recently viewed AV programs. FIG. 14 illustrates that selection of the “bookmark” tab 82 causes the UI 70 to present a list of recently viewed AV programs. The processor 16 can receive selection of an AV program on the list of recently viewed AV programs when the bookmark tab is invoked and in response to the selection add the AV program to a bookmark file.

Additional details related to the principles described above follow.

TABLE 1
Video Search Areas

| | Content Tabs: Video, Cast, | Feature Tabs: Text Search, |
|---|---|---|
| Area | Related | History, Bookmarks |
| Header | Application header | |
| Graphic | Seed image | Image for the feature |
| Tab | Mechanism to select the desired tab. Users scroll up and | |
| Navigation | down to navigate between the tabs. | |
| Seed Header | Content type icon & Seed | Text Search: Content type |
| | of search | icon & Search string |
| | | (or blank if no seed) |
| | | History & Bookmarks: |
| | | Title of tab |
| Content Area | Information about the seed, | Search: Search Results |
| | Add to Bookmarks button*, | History: History of selected |
| | Search Apps button* | seeds |
| | *Details View only | Bookmarks: List of user- |
| | | saved seeds. |
| Search Apps | Initiate Search Apps | Not displayed |
| button | feature - hidden in list view | |
| Add to | Add current seed to | Not displayed |
| Bookmarks | Bookmarks - hidden in | |
| button | list view | |
| Links | Links related to content area. | Not displayed |
| Footer | Application footer | |

*This is the text displayed in the footer when the focus is on a tab. When the focus is on a text screen (pop-up window), the text string for <RETURN> is “Back.”

### Format of the Content Area

The Content area can present data in two formats: details view and list view.
Details view: one result with many details about the result. Often includes paragraphs of description. For an example, refer to the Video tab when the seed=video.
List view: many results with few details about each result. For an example, refer to the Video tab when the seed=cast
   If there is no seed, then the Content tabs may be grayed out, in which case the UI 70 never gives them focus. The text in the seed header area depends upon the tab. For Video, Cast, or Related Tabs, the content type icon and seed may be displayed, but if there is no seed, users in some embodiments cannot access these tabs. For the text search tab content type icon and search string are displayed and if the user has not yet performed a search, then the header may display a generic text search icon and the string “text search.”

When the user selects the add to bookmarks button, the UI adds the current seed as a bookmark. This button is displayed in the content area of the Content tabs, when the tabs are in description view. The button is hidden when the tab is in list view.

As described above, the “Available On” links are links that are related to the seed. They are populated by the server-side database (management server 32). If there is no data from the database, then the UI displays the message, “Nothing available.” When a user scrolls to these links, the right pane expands to display text about each item. This content can be refreshed ever time the user selects a new seed. The text next to each link is specific to Video Search. Each item can support up to three lines of text. The text is as follows:
Line 1: Name of Service
Line 2: Name of Video/Cast Member
Line 3: Cost of Service

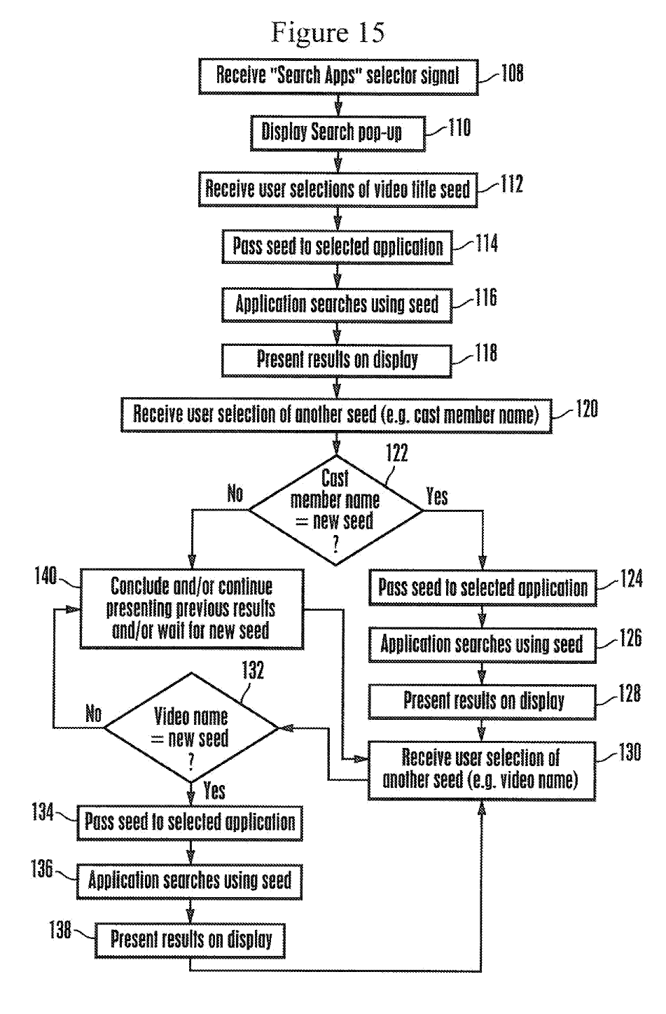

Concluding with FIG. 15, a flow chart showing example “search apps” logic illustrating recursive searching is shown. Commencing at block 108, the processor receives from a viewer operating the UI of FIG. 4, a window (labeled “Content Area”) of which presents broadcast TV or Internet video content, a selection of a “Video Search” application indicating viewer desire to obtain information about a currently playing video program in accordance with present principles. Responsive to selection of the “Video Search” application (or in alternative embodiments, an “information” selector element), at block 110 the pop-up UI of FIG. 5 is overlaid onto the UI of FIG. 4, although, as indicated above, the UI of FIG. 5 can completely replace the UT of FIG. 4 in some embodiments. Regardless, user selection of a “seed”, such as, e.g., a video title, is received at block 112 and passed to a selected application at block 114. The application searches a predetermined database (that may or may not be an Internet server) at block 116 for matching content and returns the content for presentation on the display 18 at block 118. For example, at block 118 the logic may present a description of the video associated with the video title received at block 112, and may also present a list of cast members from the video. However, differing from the logic of FIG. 3 described above, the logic of FIG. 15 continues to block 120 where a user continues searching using the “Video Search” application in accordance with present principles.

Thus, the exemplary logic of FIG. 15 continues to block 120 where user selection of another seed is received, such as, e.g., a cast member name from the list of cast members presented on the display 18 at block 118. However, it is to be understood that a seed related to content other than a cast member name from the list of cast members presented at block 118 may be received at block 120 (e.g., a seed related to a writer or director associated with the video). It is to be further understood that a seed unrelated to the content presented at block 118 may also be received at block 120.

Then, at decision diamond 122, the logic determines whether the cast member name received at block 120 is a new seed and/or a seed different than the one received at block 112. If the logic determines that the seed received at block 120 is identical to the seed received at block 112, the logic skips to block 140 where the logic may conclude, continue presenting the results presented at block 118 on the display 18, and/or await receipt of a new and/or different seed (and thereafter return to, e.g., block 120 where the logic receives a new and/or different seed). However, if the logic determines at diamond 122 that the seed received at block 120 is new and/or different from the seed received at block 112, the exemplary logic instead moves to block 124.

At block 124 the new and/or different seed is passed to a selected application. The application then searches a predetermined database at block 126 for matching content (e.g., relating to the cast member) and returns the content for presentation on the display 18 at block 128. For example, at block 128 the logic may present a brief biography of the cast member associated with the cast member name received at block 120, and may also present a list of videos or other AV programs in which the cast member has participated and/or is associated. Note that the database searched at block 126 may be the same or different than the database searched at block 116.

The exemplary logic of FIG. 15 may then proceed to block 130, further illustrating the recursive searching described herein. At block 130 another user selection of a seed is received such as, e.g., a video name from the list of videos with which the cast member is associated that was presented on the display 18 at block 128. However, it is to be understood that a seed related to content other than a video name from the list of videos presented at block 128 may be received at block 130 (e.g., a seed related to a writer or director associated with the video). It is to be further understood that a seed unrelated to the content presented at either block 118 or block 128 may also be received at block 130.

Regardless, the logic moves from block 130 to decision diamond 132. At diamond 132, the logic determines whether the video name received at block 130 is a new seed and/or a seed different than the one received at block 120. If the logic determines at diamond 132 that the seed received at block 130 is identical to the seed received at block 120, the logic skips to block 140 where the logic may conclude, continue presenting the results presented at block 128 on the display 18, and/or await receipt of a new and/or different seed (and thereafter return to, e.g., block 120 or block 130 where the logic receives a new seed and/or different seed). However, if the logic determines at diamond 132 that the seed received at block 130 is new and/or different from the seed received at block 120, the logic instead moves to block 134.

At block 134 the new and/or different seed is passed to a selected application. The application then searches a predetermined database at block 136 for matching content and returns the content for presentation on the display 18 at block 138. For example, at block 138 the logic may present a description of the video associated with the video title received at block 130, and may also present a list of cast members from the video. Furthermore, note that the predetermined database searched at block 136 may be the same or different than the databases searched at block 116 and block 126. Last, after block 138, the logic may revert back to block 120 or block 130 where the logic receives another user selection of a seed such as a cast member name from the list of cast members presented on the display 18 at block 138 is received.

It may therefore be appreciated from the exemplary logic of FIG. 15 that reversion back to block 120 or block 130 from block 138 demonstrates the kind of recursive, and potentially infinite, searching observed in the present application. Furthermore, the recursive searching described above may include seeds related not just videos and cast members but to other non-limiting categories and/or subject matter such as, but not limited to, other categories and/or subject matter disclosed in the present application (e.g., writers and directors associated with the video).

Extrapolating from the description of FIG. 15, the “Video Search” application may therefore display metadata about an AV program. The metadata may include information about the AV program itself and the cast members of the AV program (e.g., actors, directors, and writers). In some embodiments, this AV program may be considered the seed used to retrieve the metadata from, e.g., a database on a third party server that is not an Internet server. However, it is to be understood that in other embodiments, the server may be an Internet server and/or a search performed in accordance with present principles may be an Internet search.

Further extrapolating from the description of FIG. 15, the metadata may also include links to additional metadata and/or information. Thus, when a user selects a link in the metadata, the string and/or category associated with the link becomes the new seed. The “Video Search” application may then search the new seed to return metadata related to that seed. Thus, the recursive browsing described herein includes, e.g., a user selecting a link from metadata presented on the display 18. The seed associated with the link becomes the new seed and metadata relating to the new seed is displayed. A user may then select another link from the metadata relating to the new seed, and the user may repeat the above link selection as many times as desired, each time causing different metadata to be displayed.

It is to be understood that it is desired, though not required, that this metadata be displayed to the user almost instantaneously, depending on variables such as, e.g., AV device processor capabilities and network connections. Additionally, it is to be understood that in exemplary embodiments a user may select and/or input seeds through a RC or keyboard, and that a personal computer separate from the AV display device is not used.

As but one brief example of the searching contemplated by the present application, assume a user is reading metadata on a display about the original Star Wars movie. The user then selects the name George Lucas from a link in the metadata, and the “Video Search” application then changes the metadata to reflect information about George Lucas rather than the original Star. Wars movie.

While the particular VIDEO SEARCHING USING TV AND USER INTERFACES THEREFOR is herein shown and described in detail, it is to be understood that the subject matter which is encompassed by the present invention is limited only by the claims.

What is claimed is:

1. A method, comprising:
receiving, from a viewer watching an audio-video (AV) program on a video display, selection of a “Video Search” application indicating viewer desire to obtain information about a currently playing AV program;
responsive to selection of the “Video Search” application, invoking the “Video Search” application;
executing the “Video Search” application to send a name of the currently playing AV program to a server associated with a database to cause the server to execute a search of the database;
receiving from the server metadata related to the currently playing AV program, the metadata including information about the currently playing AV program and the cast thereof;
presenting information from the metadata related to the currently playing AV program on the video display along with the currently playing AV program;
executing the “Video Search” application to send a name of a cast member associated with the currently playing AV program to a server associated with a database to cause the server to execute a search of the database associated with the server responsive to viewer input indicating viewer desire to obtain information about the cast member;
receiving from the server metadata related to the cast member, the metadata including information about the cast member and/or the names of AV programs with which the cast member is associated; and
presenting information from the metadata related to the cast member on the video display along with the currently playing AV program.

2. The method of claim 1, further comprising:
executing the “Video Search” application to send a name of a second AV program with which the cast member is associated that is different than the currently playing AV program to a server associated with a database to cause the server to execute a search of the database associated with the server responsive to viewer input indicating viewer desire to obtain information about the second AV program;
receiving from the server metadata related to the second AV program, the metadata including information about the second AV program and the cast thereof; and
presenting information from the metadata related to the second AV program on the video display along with the currently playing AV program.

3. The method of claim 1, wherein the metadata related to the currently playing AV program presented on the video display further includes information relating to writers and directors of the current AV program.

4. The method of claim 1, wherein the metadata related to the cast member presented on the video display includes bibliographic information of the cast member and the names of AV programs with which the cast member is associated.

5. The method of claim 1, wherein the “Video Search” application causes the server to execute searches only of a database(s) associated with an Internet server(s) and not to execute searches of the Internet.

6. The method of claim 1, wherein the database searched for metadata relating to the name of the currently playing AV program is performed on the same database as the database searched for metadata relating to the cast member.

7. The method of claim 1, wherein the database searched for metadata relating to the name of the currently playing AV program is performed on a different database than the database searched for metadata relating to the cast member.

8. The method of claim 1, wherein the metadata related to the currently playing AV program and presented on the video display further includes at least one link associated with the cast member's name selectable to cause executing of the “Video Search” application responsive to selection of the link to send the name of a cast member associated with the currently playing AV program to the server associated with a database to cause the server to execute a search of the database associated with the server.

9. The method of claim 8, wherein the link is selectable by a viewer using a TV remote control and/or a keyboard to select the link and not a computer.

10. The method of claim 1, further comprising:
receiving from the viewer a search command to search for information related to an AV program not being presented on the video display;
responsive to the search command, presenting on the video display a search tab;
receiving user input to the search tab;
responsive to the user input to the search tab, sending the user input to the search tab to a server and causing the server to execute a database search for information related to the user input to the search tab;
receiving from the server metadata related to the AV program not being presented on the video display, the metadata including information about the AV program not being presented on the video display; and
presenting information from the metadata related to AV program not being presented on the video display along with the currently playing AV program.

11. An audio video (AV) device comprising:
a video display presenting a currently input AV program; and
a processor accessing instructions on a computer readable medium to execute the instructions to control the video display to present a user interface (UI) on the video display while simultaneously presenting an AV program on the video display, the UI including an “information” selector element, the processor responsive to selection of the “information” selector element presenting on the video display first metadata relating to the AV program, the processor responsive to selection of a link in the first metadata replacing the first metadata with second metadata relating to subject matter associated with the link and different from the subject matter of the first metadata.

12. The AV device of claim 11, wherein the AV device is not a personal computer.

13. The AV device of claim 11, wherein the link is selected using a remote commander and/or keyboard.

14. The AV device of claim 11, wherein the processor responsive to selection of a link in the second metadata replaces the second metadata with third metadata relating to the subject matter associated with the link and different from the subject matter of the first and second metadata.

15. The AV device of claim 11, wherein the processor executes a database search for the respective metadata to be presented on the video display.

16. The AV device of claim 15, wherein respective metadata presented on the video display includes the results of the respective database search.

17. The AV device of claim 11, wherein the first metadata includes information relating to the AV program, including a description of the AV program, and the second metadata includes information relating to a cast member associated with the AV program.

18. A method, comprising:
receiving, from a viewer watching an audio-video (AV) program on a video display of an AV device, selection of a “search” selector element from a UI presented on the video display indicating viewer desire to obtain information about an AV program currently presented on the AV device;
responsive to selection of the “search” selector element, invoking a search application;
executing the search application to send a name of the AV program to a server associated with a database to cause the server to execute a search of the database;
receiving from the server metadata related to the AV program, the metadata including information about the AV program;
presenting information from the metadata on the video display;
executing the search application at least a second time to send a seed other than the name of the AV program to a server associated with a database to cause the server to execute a search of the database, wherein the seed was derived from the information about the AV program presented on the video display, responsive to viewer input indicating viewer desire to obtain information about the seed other than the name of the AV program;
receiving from the server metadata related to the seed, the metadata including supplementary information related to the first seed; and
presenting the supplementary information from the metadata on the video display.

19. The method of claim 17, wherein the seed other than the name of the AV program is the name of a cast member associated with the currently playing AV program.

20. The method of claim 18, wherein the supplementary information includes bibliographic information of the cast member and/or the names of AV programs with which the cast member is associated.
